(19) United States
(12) Patent Application Publication
(10) Pub. No.: US 2005/0059296 A1
(43) Pub. Date: Mar. 17, 2005

(54) Electrical connector having reduced variation range of characteristic impedance

(76) Inventor: ZhenSheng Wang, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/943,435

(22) Filed: Sep. 16, 2004

(30) Foreign Application Priority Data
Sep. 17, 2003 (CN) 03279389.8

(51) Int. Cl. H01R 13/60

(52) U.S. Cl. 439/541.5

(57) ABSTRACT

An electrical connector (1) includes an insulative housing (10), a number of terminals (20) and a shielding shell. The housing includes a body portion, (11), a mating portion (12) extending forwardly from the body portion and a number of passageways (124) defined therein. The terminals includes a number of digital signal, power, grounding and analog signal terminals (221, 222, 223). The terminals have four groups (21, 22, 23, 24) arrayed in rows. The group (22) of terminals includes three analog signal terminals. The distance between the adjacent two analog signal terminals is twice the distance between adjacent two other types of terminals except the analog signal terminals, thereby reducing variation range of characteristic impedance of the connector.

### BACKGROUND OF THE INVENTION

1. Field of the Invention

The present invention is related to an electrical connector, and more particularly to a Mini Digital Visual Interface (MDVI or Mini DVI) electrical connector mounted onto a printed circuit board.

2. Description of Related Art

With the rapid development of today's electronic products, transfer rate and data storage capacity of the electronic products are increased to a great extent. In such high frequency and high-speed electronic equipments, it is desirable that all electronic components of an interconnection path be optimized for signal transmission characteristics, otherwise the signal integrity of the system will be impaired or degraded. Obviously high frequency characteristics of the electronic components, such as risetime degradation or system bandwidth, crosstalk, impedance control and propagation delay, play a significant role in signal transmission. When transmitting high-speed data signals through a conductive transmission medium, the integrity of the received signals depends on the impedance over the signal path mainly. So impedance becomes an important considerable parameter.

It is usually very important to transfer power from one stage of an electronic device to the next. To transfer the maximum amount of power and the minimum of signal reflection, the output impedance of one stage must be the same as the input impedance of the next stage. This is so called impedance match. If a small impedance is connected to a big impedance, that is impedance mismatch, then the power that can pass through the connection is limited by the larger impedance. In general, impedance mismatch in a transmission path causes signal reflection, which leads to signal losses such as reduction in signal amplitude, cancellation of certain signals, and so on. Furthermore, part signal is reflected and transmitted to the primary stage due to signal reflection, which leads to disturb original signal and results in signal distortion. Accordingly, the more consistent the impedance over the path, the better the integrity of the received signal. Generally, each electrical component must be tested by characteristic impedance for satisfying with the certain specification requirement.

Referring to FIG. 5, the mini DVI connector can transmit two types of signal, digital signal and analog signal, and includes a plurality of digital signal terminals 31 and analog signal terminals 32, a plurality of grounding terminals 33 and power terminals (not labeled). In order to anti-EMI, a part of grounding terminals 331, 332 are respectively disposed between adjacent two analog signal terminals 321 and 322, as well as between adjacent two analog signal terminals 322 and 323. However, increasing the grounding terminals shall affect the characteristic impedance of the mini DVI connector. FIG. 6 and FIG. 7 are characteristic impedance test diagrams during the mini DVI connector transmitting analog signal. The characteristic impedance is tested by using a Time Domain Reflectometer (TDR). Horizontal coordinate and vertical coordinate of the test diagram respectively represent Time and Voltage whose standard unit are second (sec.) and volt (V), and the test curve thereof reflects variation of the characteristic impedance. FIG. 6 is a characteristic impedance test diagram of the analog signal terminal 322 and FIG. 7 is a characteristic impedance test diagram of the analog signal terminals 321, 323. The analog signal terminals 321, 323 and the analog signal terminal 322 have different characteristic impedance. The characteristic impedance specification of the analog signal terminal of the electrical connector is 75 ohms±10%, so 75 ohms is a reference value in test. As shown in FIG. 6, the minimum of the characteristic impedance is only 66.6 ohms and exceeds the specification range so that it can't satisfy with the specification requirement, thereby affecting quality of signal transmission.

Hence, it is requisite to provide an improved mini DVI connector to overcome the above-mentioned disadvantages of the related art for improving the quality of signal transmission.

### SUMMARY OF THE INVENTION

Accordingly, an object of the present invention is to provide a mini DVI electrical connector that can decrease variation range of characteristic impedance by changing terminal arrangement and simplify the mini DVI electrical connector.

In order to achieve the object set forth, a mini DVI electrical connector in accordance with the present invention can transmit digital signal and analog signal and comprises an insulative housing, a plurality of conductive terminals and a shielding shell. The insulative housing comprises a body portion, a mating portion extending forwardly from the body portion and a plurality of passageways defined therein. The conductive terminals are received in the passageways and includes a plurality of digital and analog signal terminals. The conductive terminals have plural groups arrayed in rows and conductive terminals of most groups are arrayed equidistantly. The group of conductive terminals including analog signal terminals has fewer terminals than other groups and the distance between the adjacent two analog signal terminals is twice the distance between adjacent two other types of terminals except the analog signal terminals.

Other objects, advantages and novel features of the invention will become more apparent from the following detailed description of the present embodiment when taken in conjunction with the accompanying drawings.

### BRIEF DESCRIPTION OF THE DRAWINGS

FIG. 1 is a perspective view of a mini DVI electrical connector in accordance with the present invention;

FIG. 2 is an exploded, perspective view of FIG. 1;

FIG. 3 is a characteristic impedance test diagram of an analog signal terminal of the mini DVI electrical connector of FIG. 2, which has the other two analog signals disposed at two opposite sides thereof;

FIG. 4 is a characteristic impedance test diagram of the other two analog signal terminals of the mini DVI electrical connector of FIG. 2, each of which has one analog signal terminal disposed at one side thereof;

FIG. 5 is a perspective view of a conventional mini DVI electrical connector;

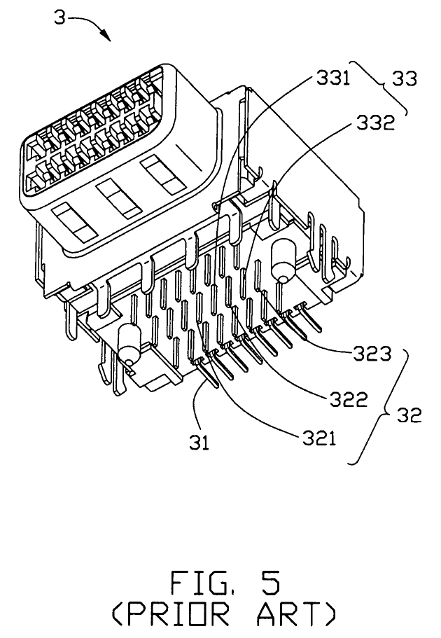

FIG. 6 is a characteristic impedance test diagram of an analog signal terminal of the conventional mini DVI electrical connector of FIG. 5, which has two grounding terminals disposed at two opposite sides thereof; and

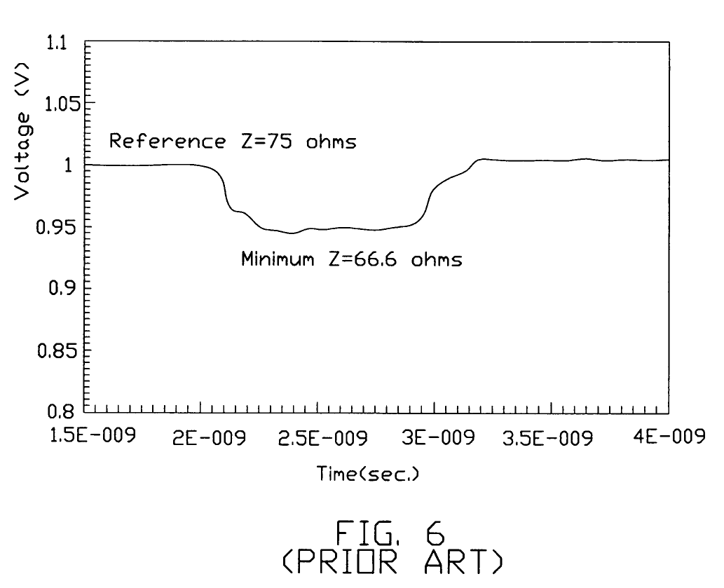

FIG. 7 is a characteristic impedance test diagram of the other two analog signal terminals of the conventional mini DVI electrical connector of FIG. 5, each of which has one grounding terminal disposed at one side thereof.

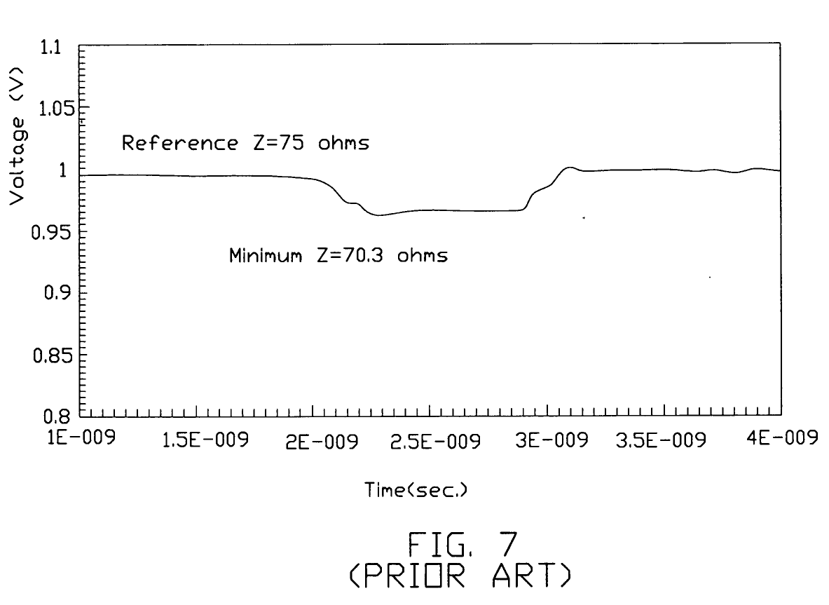

### DETAILED DESCRIPTION OF THE INVENTION

Reference will now be made in detail to the preferred embodiment of the present invention.

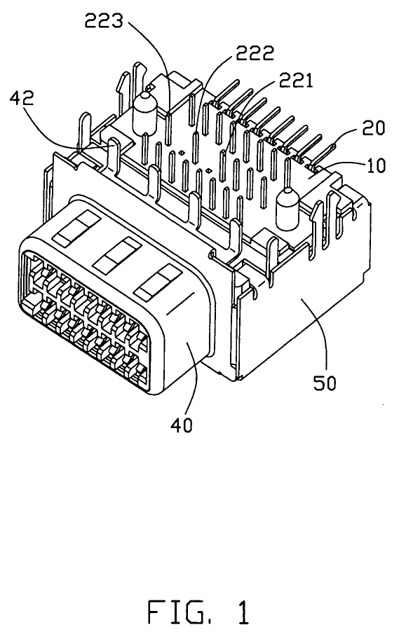

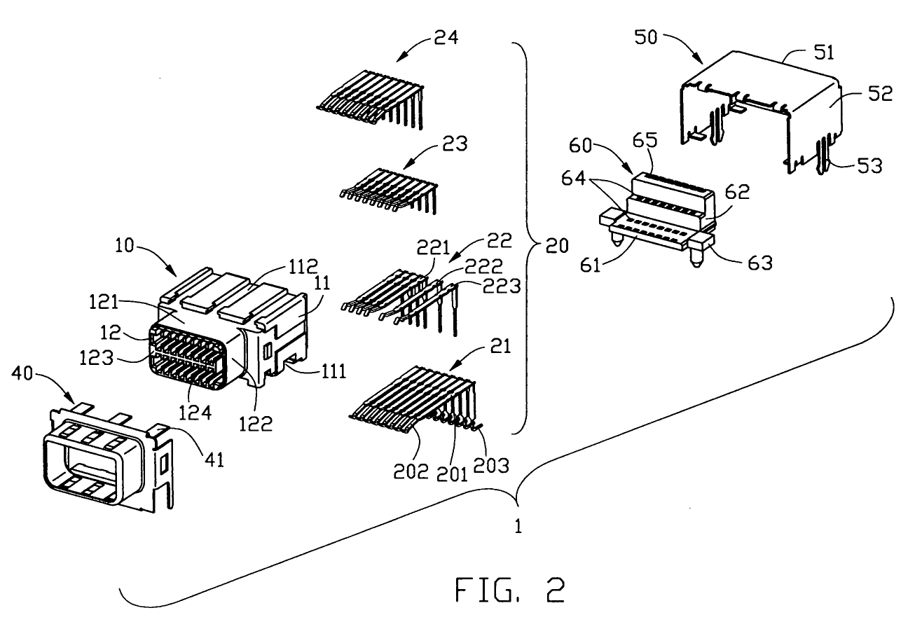

Referring to FIG. 1 and FIG. 2, a mini DVI electrical connector 1 in accordance with the present invention for transmitting visual signal comprises an insulative housing 10, a plurality of conductive terminals 20 received in the insulative housing 10, a pair of shielding shells 40, 50 enclosing the insulative housing 10 and a spacer 60 assembled at a rear portion of the insulative housing 10 for positioning the conductive terminals 20 therein.

The insulative housing 10 comprises a body portion 11 and a mating portion 12 extending forwardly from the body portion 11. The mating portion 12 has an upper wall, a lower wall 121 and a pair of side walls 122 connecting with the upper and lower walls 121. The mating portion 12 has a tongue 123 extending between the two side walls 122 and parallel to the upper and lower walls 121. A plurality of passageways 124 are respectively defined on a bottom face of the upper wall 121, a top face of the lower wall 121 and two opposite faces of the tongue 123, and extending through the body portion 11 along a front-to-rear direction and arranged in four parallel rows. The insulative housing 10 defines a receiving space (not shown) in the rear portion thereof and a gap 111 in a bottom of the two sides thereof. Additionally, the insulative housing 10 defines a retaining recess 112 in a top face thereof.

The conductive terminals 20 are received in corresponding passageways 124 of the body portion 11 and the mating portion 12, and comprise a plurality of signal terminals having plural digital signal terminals (not labeled) and three analog signal terminals 221, 222, 223, and a plurality of grounding terminals and power terminals. The conductive terminals 20 are in L shape and each comprises a retention portion 201 retained in the passageway 124 of the body portion 11, a contacting portion 202 extending from one end of the retention portion 201 and received in the passageways 124 of the mating portion 12, an extension portion (not labeled) vertically extending from the other end of the retention portion 201 and a soldering portion 203 extending from the extension portion. The conductive terminals 20 have four groups 21, 22, 23, 24 arrayed in rows. Each of groups of conductive terminals 21, 23, 24 has an equal number of terminals arrayed equidistantly and adjacent two terminals are kept apart a predetermined distance. The group of conductive terminals 22 including the three analog signal terminals has fewer terminals than other three groups of conductive terminals 21, 23, 24. The three analog signal terminals 221, 222, 223 are arrayed adjacently and located in one side of the group of conductive terminal 22, and the distance between the adjacent two analog signal terminals is twice the predetermined distance. The distance between other adjacent two terminals of the group of conductive terminals 22 is the same as the predetermined distance. Furthermore, the soldering portions 203 of the groups of conductive terminals 22, 23, 24 are perpendicular to the retention portions 201 thereof, while the soldering portions 203 of the group of conductive terminals 21 is parallel to the retention portion 201 thereof.

The shielding shell comprises a first shielding shell 40 and a second shielding shell 50 enclosing the body portion 12 and the mating portion 11 of the insulative housing 10 respectively. The first shielding shell 40 forms a plurality of retaining tab 41 extending downwardly for mating with the retaining recess 112 of the insulative housing 10 to attach the first shielding shell 40 to the insulative housing 10 and a plurality of grounding leg 42 extending downwardly. The second shielding shell 50 includes a top wall 51, a rear wall (not shown) and a pair of side walls 52. The second shielding shell 50 forms a pair of board lock 53 extending downwardly from two side walls 52 thereof for latching with through holes (not shown) of a printed circuit board (not shown) to retain the mini DVI electrical connector 1 onto the printed circuit board.

The spacer 60 includes a elongated base 61, a step section 62 extending upwardly from the base 61 and a pair of protrusions 63 outwardly extending from two opposite ends of the base 61 for mating with the corresponding gaps 111 of the insulative housing 10 so as to fix the spacer 60 on the insulative housing 10. The base 61 and the step section 62 define a plurality of through holes 64 extending therethrough and the step section 62 forms a plurality of positioning slit 65 in a rear surface thereof.

In assembly, the groups of conductive terminals 21, 22, 23, 24 are received in the passageways 124 in turn with the retention portions 201 thereof received the passageways 124 of the body portion 11, and the contacting portion 202 extending out of the body portion 11 of the insulative housing 10 and received in the passageways 124 of the mating portion 12. Next the protrusions 63 of the spacer 60 engage with the gaps 111 of the insulative housing 10 so that the spacer 60 is assembled into the receiving space of the insulative housing 10 from a bottom surface of the insulative housing 10, and the extension portion of the groups of conductive terminals 22, 23, 24 are respectively inserted through the through holes 64 of the spacer 60 while the extension portions of the group of conductive terminals 21 are respectively received in the positioning slits 65 of the spacer 60 and the soldering portions 203 thereof extends beyond the bottom surface of the insulative housing 10. Finally, the first shielding shell 40 is assembled to the mating portion 12 of the insulative housing 10 with the retaining tab 41 thereof engaging with the retaining recess 112 of the insulative housing 10 and the second shielding shell 50 is assembled to the body portion 11 of the insulative housing 10 along a rear-to-front direction.

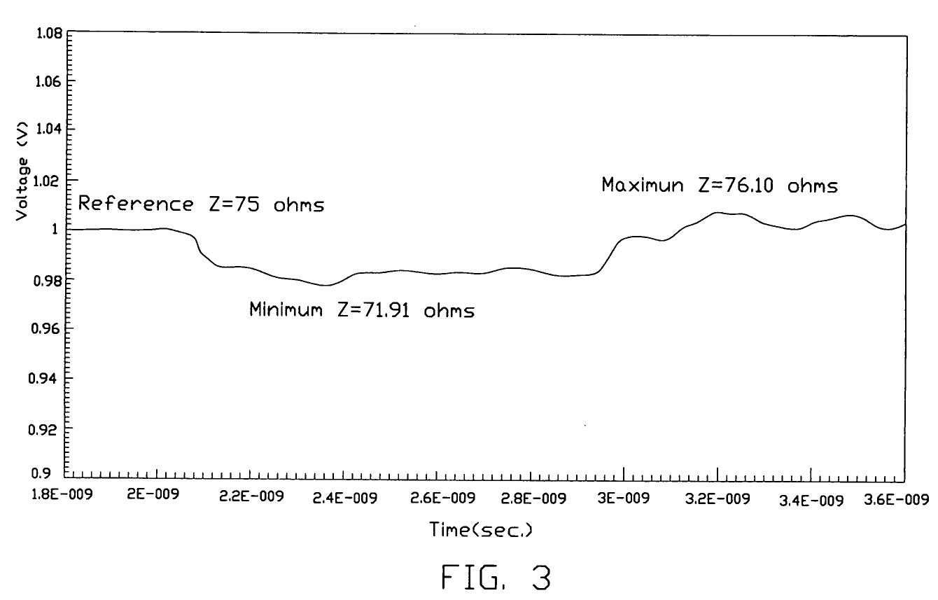

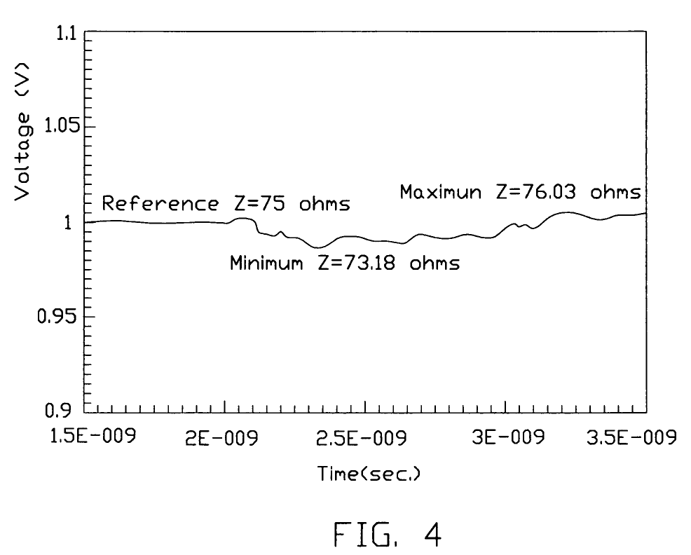

Referring to FIG. 3 and FIG. 4, FIG. 3 is a characteristic impedance test diagram of the analog signal terminal 222 between the other two analog signal terminals 221, 223 and FIG. 4 is a characteristic impedance test diagram of the other two analog signal terminals 221, 223. The characteristic impedances of the three analog signal terminals 221, 222, 223 are within the range of 75 ohms±10% so as to satisfy with the required specification of characteristic impedance.

In general, when characteristic impedance of an electrical connector was not consistent with a given impedance, it is usually adopted to increase other components for achieving impedance match. However, it will necessarily complicate the product and further result in increasing manufacturing cost of the product. Compared with the conventional connector, the electrical connector 1 in accordance with the present invention cancels a pair of grounding terminals among the analog signal terminals 221, 222, 223 so that the distance between the adjacent two terminals of the three analog signal terminals is bigger than the distance between adjacent two other types of terminals except the three analog signal terminals, thereby not only decreasing variation range of characteristic impedance of the electrical connector 1 for impedance match, but also simplifying the electrical connector 1 without increasing other components.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. An electrical connector for transmitting digital signal and analog signal, comprising:
an insulative housing comprising a body portion, a mating portion extending forwardly from the body portion and a plurality of passageways formed in the mating portion;
a plurality of conductive terminals received in said passageways, the terminals comprising a plurality of first terminals and second terminals and being arranged in at least a first and second groups, the first group of the terminals including some of the first terminals equidistantly arranged in a row, the second group of the terminals including the other first terminals and at least two second terminals arranged in a row, the distance between adjacent two second terminals being twice the distance between adjacent two first terminals; and
a shielding shell enclosing the insulative housing.

2. The electrical connector as claimed in claim 1, wherein the second group of the terminals comprises fewer terminals than the first group of the terminals.

3. The electrical connector as claimed in claim 2, wherein said second terminals are analog signal terminals and said first terminals comprise a plurality of digital signal terminals, grounding terminals and power terminals.

4. The electrical connector as claimed in claim 1, wherein each terminal comprises a retention portion retained in a corresponding passageway of the body portion, a contacting portion extending from one end of the retention portion and received in the corresponding passageway of the mating portion, an extension portion vertically extending from the other end of the retention portion and a soldering portion extending beyond the insulative housing.

5. The electrical connector as claimed in claim 4, further comprising a spacer assembled onto the insulative housing and wherein the spacer comprises a base and a step section extending upwardly from the base.

6. The electrical connector as claimed in claim 5, wherein said base and said step section define a plurality of through holes extending therethrough.

7. The electrical connector as claimed in claim 6, wherein said step section forms a plurality of positioning slits in a rear surface thereof.

8. The electrical connector as claimed in claim 1, wherein said mating portion of the insulative housing has an upper wall, a lower wall, a pair of side walls connecting with the upper and the lower walls and a tongue extending between and parallel to the upper and lower walls.

9. The electrical connector as claimed in claim 8, wherein said passageways are defined in the top and bottom surfaces of the tongue and said upper and bottom walls of the mating portion and the body portion.

10. The electrical connector as claimed in claim 1, wherein said shielding shell comprises a first shielding shell and a second shielding shell enclosing the mating portion and the body portion of the insulative housing respectively.

11. An electrical connector comprising:
an insulative housing defining a plurality of passageways;
a plurality of digital signal contacts disposed in some of the passageways, respectively;
a plurality of analog signal contacts disposed in others of the passageways, respectively;
a distance between every two adjacent analog signal contacts is larger than that between every two adjacent digital contacts; wherein
at least one empty passageway without any grounding contact therein is located between said every two adjacent analog signal contacts.

12. The electrical connector as claimed in claim 11, further including a spacer defining a plurality of through holes through which tails of the contacts extend respectively, wherein the through hole aligned with said empty passageway receives no tail therein.
